(19) United States
(12) Patent Application Publication
(10) Pub. No.: US 2026/0088861 A1
(43) Pub. Date: Mar. 26, 2026

(54) PRECODING ALGORITHM FOR CIRCULATOR-LESS RADIO ARCHITECTURES

(71) Applicant: Telefonaktiebolaget LM Ericsson (publ), Stockholm (SE)

(72) Inventor: Pierre-Andre LAPORTE, Gatineau (CA)

(73) Assignee: Telefonaktiebolaget LM Ericsson (publ), Stockholm (SE)

(21) Appl. No.: 19/112,587

(22) PCT Filed: Oct. 7, 2022
(86) PCT No.: PCT/IB2022/059631

§ 371 Date: Mar. 17, 2025

(51) Int. Cl. H04B 7/0452; H04B 7/0456

(52) U.S. Cl. CPC H04B 7/0452; H04B 7/0456

(57) ABSTRACT

A method, system and apparatus are disclosed. A system including at least one wireless device and a network node configured to communicate with the at least one wireless device is provided. The network node includes an antenna array including a plurality of antennas. The network node is configured to determine at least one precoding matrix based on a Douglas-Rachford splitting convex optimization model between a per-antenna power constraint and a Multi-User Interference (MUI) requirement for evening the output power of the plurality of antennas of the antenna array. The network node is configured to cause transmission to the at least one wireless device using the antenna array based at least in part on the at least one precoding matrix.

### TECHNICAL FIELD

The present disclosure relates to wireless communications, and in particular, to precoding for circulator-less radio architectures.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. 3GPP is also working on Sixth Generation (6G) wireless communication systems.

The release of frequency bands above 6 GHz for wireless communications has encouraged the adoption of Massive-MIMO radios with very large antenna arrays. In order to reduce the hardware cost and yield compact radio solutions, some of the traditional radio hardware components, such as circulators, may be removed. Circulators are typically used to isolate the power amplifier (PA) from reflected waves.

The linearity and efficiency of a PA depend on the input power level as well as the terminating impedance. In the presence of antenna crosstalk, the terminating impedance can vary depending on the power levels of neighboring antennas. Thus, power imbalances between adjacent branches can create load modulation issues, which in turn deteriorate the PA efficiency and linearity in circulator-less radio architectures.

One existing antenna beamforming technique is a Zero-Forcing Precoder, which may minimize the total transmit power, and is widely employed in existing systems due to its simplicity. The Zero-Forcing Precoder may, however, produce uneven power levels across the antennas, and thus may not be a suitable precoding algorithm for some circulator-less radio architectures.

For example, in one existing solution, a per-antenna power constraint is applied to the matrix inverse problem, i.e., a convex second-order cone program. This problem may be solved using primal-dual interior-point methods with standard optimization packages, which may be useful in offline experiments, but are typically not optimal for real-time processing.

Thus, existing systems may lack adequate precoding and optimization for circulator-less radio architectures.

### SUMMARY

There is therefore a need for low implementation cost beamforming techniques which may produce relatively more even power levels across the antennas in reciprocity-based transmissions, and which may be suitable for real-time processing.

Some embodiments advantageously provide methods, systems, and apparatuses for precoding in circulator-less radio architectures.

In some embodiments of the present disclosure, a composite convex problem formulation is computed and solved/estimated using, e.g., a few iterations (for example, four iterations) of the Douglas-Rachford splitting algorithm. In some embodiments, an iterative algorithm may solve the joint optimization problem of the channel matrix inverse and the per-antenna power constraint.

Embodiments of the present disclosure may provide one or more of the following benefits:
In some embodiments, the processing (e.g., for precoding optimization) may be partially or entirely done in the frequency-domain at the baseband sampling rate, which may lead to moderate/improved computational complexity and latency costs (e.g., compared to some existing solutions).

In some embodiments, the optimization computation converges in a number N of iterations, e.g., three iterations. In some embodiments, a small number (e.g., only one) iteration may be needed to reach a solution, such that the algorithm could be stopped early (e.g., earlier than a configured/target/maximum/etc. number of iterations, at a predefined error value, etc.).

In some embodiments, the optimization results in a significant reduction (e.g., compared to existing solutions) of the power variations across the antenna branches, e.g., in reciprocity-assisted transmissions (RAT);

In some embodiments, the optimization procedure may be transparent to the scheduled wireless device(s), provided a sufficient channel estimation refresh rate.

In some embodiments, the optimization procedure may result in a moderate average power increase, as compared to existing solutions that require a greater power increase.

According to one aspect of the present disclosure, a network node in communication with a wireless device is provided. The network node includes an antenna array and processing circuitry. The network node is configured to determine at least one precoding matrix based on a Douglas-Rachford splitting convex optimization model between a per-antenna power constraint and a Multi-User Interference (MUI) requirement for evening the output power of the plurality of antennas of the antenna array. The network node is configured to cause transmission to the at least one wireless device using the antenna array based at least in part on the at least one precoding matrix.

According to one or more embodiments of this aspect, the determining of the at least one precoding matrix based on the Douglas-Rachford splitting convex optimization model includes initializing an intermediate error accumulator variable Z according to Z⁻¹=0. According to one or more embodiments of this aspect, the determining of the at least one precoding matrix based on the Douglas-Rachford splitting convex optimization model includes initializing a variable X according to one of a zero forcing solution, where the zero forcing solution is either regularized or not regularized, and a reshuffling of the Douglas-Rachford operations for improved algorithmic efficiency, where X is a matrix formed by horizontally stacking a plurality of antenna-domain solutions x for a plurality of subcarriers.

According to one or more embodiments of this aspect, the determining of the at least one precoding matrix based on the Douglas-Rachford splitting convex optimization model includes stopping the optimization model computation prior to reaching a minimum, where the stopping is based on at least one of a complexity of computation, a target per-antenna power spread value, a total additive perturbation power value, and an algorithm iteration count. According to one or more embodiments of this aspect, the optimization model is based on a first proximal operator associated with a projection of additive perturbations to a channel null space, and a second proximal operator associated with a per-antenna power rescaling. According to one or more embodiments of this aspect, the determining of the at least one precoding matrix based on the Douglas-Rachford splitting convex optimization model includes determining at least one projection matrix based on at least one of sounding reference signal, SRS, channel estimates, demodulation reference signal, DMRS, channel estimates, and second order channel statistics generated from processing at least one uplink physical channel. According to one or more embodiments of this aspect, the second order channel statistics are received with a higher periodicity than the SRS channel estimates. According to one or more embodiments of this aspect, the second order channel statistics include channel estimates associated with at least one of another wireless device and another network node.

According to another aspect of the present disclosure, a method implemented in a network node in communication with a wireless device is provided. The network node includes an antenna array and processing circuitry. At least one precoding matrix is determined based on a Douglas-Rachford splitting convex optimization model between a per-antenna power constraint and a Multi-User Interference (MUI) requirement for evening the output power of the plurality of antennas of the antenna array. At least one transmission is transmitted to at least one wireless device using the antenna array based at least in part on the at least one precoding matrix.

According to one or more embodiments of this aspect, the determining of the at least one precoding matrix based on the Douglas-Rachford splitting convex optimization model includes initializing an intermediate error accumulator variable Z according to Z⁻¹=0. According to one or more embodiments of this aspect, the determining of the at least one precoding matrix based on the Douglas-Rachford splitting convex optimization model includes initializing a variable X according to one of a zero forcing solution, where the zero forcing solution is either regularized or not regularized, and a reshuffling of the Douglas-Rachford operations for improved algorithmic efficiency, where X is a matrix formed by horizontally stacking a plurality of antenna-domain solutions x for a plurality of subcarriers.

According to one or more embodiments of this aspect, the determining of the at least one precoding matrix based on the Douglas-Rachford splitting convex optimization model includes stopping the optimization model computation prior to reaching a minimum, where the stopping is based on at least one of a complexity of computation, a target per-antenna power spread value, a total additive perturbation power value, and an algorithm iteration count. According to one or more embodiments of this aspect, the optimization model is based on a first proximal operator associated with a projection of additive perturbations to a channel null space, and a second proximal operator associated with a per-antenna power rescaling. According to one or more embodiments of this aspect, the determining of the at least one precoding matrix based on the Douglas-Rachford splitting convex optimization model includes determining at least one projection matrix based on at least one of sounding reference signal, SRS, channel estimates, demodulation reference signal, DMRS, channel estimates, and second order channel statistics generated from processing at least one uplink physical channel. According to one or more embodiments of this aspect, the second order channel statistics are received with a higher periodicity than the SRS channel estimates. According to one or more embodiments of this aspect, the second order channel statistics include channel estimates associated with at least one of another wireless device and another network node.

According to another aspect of the present disclosure, a wireless communication system including a wireless device and a network node in communication with a wireless device is provided. The network node includes an antenna array and processing circuitry. The network node is configured to determine at least one precoding matrix based on a Douglas-Rachford splitting convex optimization model between a per-antenna power constraint and a Multi-User Interference (MUI) requirement for evening the output power of the plurality of antennas of the antenna array. The network node is configured to cause transmission to the at least one wireless device using the antenna array based at least in part on the at least one precoding matrix.

According to one or more embodiments of this aspect, the determining of the at least one precoding matrix based on the Douglas-Rachford splitting convex optimization model includes initializing an intermediate error accumulator variable Z according to Z⁻¹=0. According to one or more embodiments of this aspect, the determining of the at least one precoding matrix based on the Douglas-Rachford splitting convex optimization model includes initializing a variable X according to one of a zero forcing solution, where the zero forcing solution is either regularized or not regularized, and a reshuffling of the Douglas-Rachford operations for improved algorithmic efficiency, where X is a matrix formed by horizontally stacking a plurality of antenna-domain solutions x for a plurality of subcarriers.

According to one or more embodiments of this aspect, the determining of the at least one precoding matrix based on the Douglas-Rachford splitting convex optimization model includes stopping the optimization model computation prior to reaching a minimum, where the stopping is based on at least one of a complexity of computation, a target per-antenna power spread value, a total additive perturbation power value, and an algorithm iteration count. According to one or more embodiments of this aspect, the optimization model is based on a first proximal operator associated with a projection of additive perturbations to a channel null space, and a second proximal operator associated with a per-antenna power rescaling. According to one or more embodiments of this aspect, the determining of the at least one precoding matrix based on the Douglas-Rachford splitting convex optimization model includes determining at least one projection matrix based on at least one of sounding reference signal, SRS, channel estimates, demodulation reference signal, DMRS, channel estimates, and second order channel statistics generated from processing at least one uplink physical channel. According to one or more embodiments of this aspect, the second order channel statistics are received with a higher periodicity than the SRS channel estimates. According to one or more embodiments of this aspect, the second order channel statistics include channel estimates associated with at least one of another wireless device and another network node.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating example methods implemented in a communication system including a host computer, a network node and a wireless device for executing a client application at a wireless device according to some embodiments of the present disclosure;

FIG. 4 is a flowchart illustrating example methods implemented in a communication system including a host computer, a network node and a wireless device for receiving user data at a wireless device according to some embodiments of the present disclosure;

FIG. 5 is a flowchart illustrating example methods implemented in a communication system including a host computer, a network node and a wireless device for receiving user data from the wireless device at a host computer according to some embodiments of the present disclosure;

FIG. 6 is a flowchart illustrating example methods implemented in a communication system including a host computer, a network node and a wireless device for receiving user data at a host computer according to some embodiments of the present disclosure;

FIG. 7 is a flowchart of an example process in a network node for precoding in circulator-less radio architectures according to some embodiments of the present disclosure;

FIG. 8 is a flowchart of an example process in a wireless communication system for precoding in circulator-less radio architectures according to some embodiments of the present disclosure;

FIG. 9 depicts an example per-antenna power spread Empirical Cumulative Distribution Function (ECDF) across several iterations of precoding optimization, according to some embodiments of the present disclosure;

FIG. 10 depicts example power contributions ECDF across several iterations of precoding optimization, according to some embodiments of the present disclosure;

FIG. 11 depicts another example per-antenna power spread ECDF across several iterations of precoding optimization, according to some embodiments of the present disclosure; and

FIG. 12 depicts another example power contributions ECDF across several iterations of precoding optimization, according to some embodiments of the present disclosure.

### DETAILED DESCRIPTION

Before describing in detail example embodiments, it is noted that the embodiments reside primarily in combinations of apparatus components and processing steps related to precoding in circulator-less radio architectures. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

An antenna arrangement may include one or more antenna elements (radiating elements), which may be combined in antenna arrays. An antenna array or subarray may include one antenna element, or a plurality of antenna elements, which may be arranged e.g., two dimensionally (for example, a panel) or three dimensionally. It may be considered that each antenna array or subarray or element is separately controllable, respectively that different antenna arrays are controllable separately from each other. A single antenna element/radiator may be considered the smallest example of a subarray. Examples of antenna arrays comprise one or more multi-antenna panels or one or more individually controllable antenna elements. An antenna arrangement may include a plurality of antenna arrays. It may be considered that an antenna arrangement is associated to a (specific and/or single) radio node, e.g., a configuring or informing or scheduling radio node, e.g., to be controlled or controllable by the radio node. An antenna arrangement associated to a WD or terminal may be smaller (e.g., in size and/or number of antenna elements or arrays) than the antenna arrangement associated to a network node. Antenna elements of an antenna arrangement may be configurable for different arrays, e.g., to change the beamforming characteristics. In particular, antenna arrays may be formed by combining one or more independently or separately controllable antenna elements or subarrays. The beams may be provided by analog beamforming, or in some variants by digital beamforming, or by hybrid beamforming combing analog and digital beamforming. The informing radio nodes may be configured with the manner of beam transmission, e.g., by transmitting a corresponding indicator or indication, for example as beam identify indication. However, there may be considered cases in which the informing radio node/s are not configured with such information, and/or operate transparently, not knowing the way of beamforming used. An antenna arrangement may be considered separately controllable in regard to the phase and/or amplitude/power and/or gain of a signal feed to it for transmission, and/or separately controllable antenna arrangements may comprise an independent or separate transmit and/or receive unit and/or ADC (Analog-Digital-Converter, alternatively an ADC chain) or DCA (Digital-to-Analog Converter, alternatively a DCA chain) to convert digital control information into an analog antenna feed for the whole antenna arrangement (the ADC/DCA may be considered part of, and/or connected or connectable to, antenna circuitry) or vice versa. A scenario in which an ADC or DCA is controlled directly for beamforming may be considered an analog beamforming scenario; such controlling may be performed after encoding/decoding and/or after modulation symbols have been mapped to resource elements. This may be on the level of antenna arrangements using the same ADC/DCA, e.g., one antenna element or a group of antenna elements associated to the same ADC/DCA. Digital beamforming may correspond to a scenario in which processing for beamforming is provided before feeding signaling to the ADC/DCA, e.g., by using one or more precoder/s and/or by precoding information, for example before and/or when mapping modulation symbols to resource elements. Such a precoder for beamforming may provide weights, e.g., for amplitude and/or phase, and/or may be based on a (precoder) codebook, e.g., selected from a codebook. A precoder may pertain to one beam or more beams, e.g., defining the beam or beams. The codebook may be configured or configurable, and/or be predefined.

DFT beamforming may be considered a form of digital beamforming, wherein a DFT procedure is used to form one or more beams. Hybrid forms of beamforming may be considered.

A beam may be defined by a spatial and/or angular and/or spatial angular distribution of radiation and/or a spatial angle (also referred to as solid angle) or spatial (solid) angle distribution into which radiation is transmitted (for transmission beamforming) or from which it is received (for reception beamforming). Reception beamforming may comprise only accepting signals coming in from a reception beam (e.g., using analog beamforming to not receive outside reception beam/s), and/or sorting out signals that do not come in in a reception beam, e.g., in digital postprocessing, e.g., digital beamforming. A beam may have a solid angle equal to or smaller than 4*pi sr (4*pi correspond to a beam covering all directions), in particular smaller than 2*pi, or pi, or pi/2, or pi/4 or pi/8 or pi/16. In particular for high frequencies, smaller beams may be used. Different beams may have different directions and/or sizes (e.g., solid angle and/or reach). A beam may have a main direction, which may be defined by a main lobe (e.g., center of the main lobe, e.g., pertaining to signal strength and/or solid angle, which may be averaged and/or weighted to determine the direction), and may have one or more sidelobes. A lobe may generally be defined to have a continuous or contiguous distribution of energy and/or power transmitted and/or received, e.g., bounded by one or more contiguous or contiguous regions of zero energy (or practically zero energy). A main lobe may comprise the lobe with the largest signal strength and/or energy and/or power content. However, sidelobes usually appear due to limitations of beamforming, some of which may carry signals with significant strength, and may cause multi-path effects. A sidelobe may generally have a different direction than a main lobe and/or other side lobes, however, due to reflections a sidelobe still may contribute to transmitted and/or received energy or power. A beam may be swept and/or switched over time, e.g., such that its (main) direction is changed, but its shape (angular/solid angle distribution) around the main direction is not changed, e.g., from the transmitter's views for a transmission beam, or the receiver's view for a reception beam, respectively. Sweeping may correspond to continuous or near continuous change of main direction (e.g., such that after each change, the main lobe from before the change covers at least partly the main lobe after the change, e.g., at least to 50 or 75 or 90 percent). Switching may correspond to switching direction non-continuously, e.g., such that after each change, the main lobe from before the change does not cover the main lobe after the change, e.g., at most to 50 or 25 or 10 percent.

Signal strength may be a representation of signal power and/or signal energy, e.g., as seen from a transmitting node or a receiving node. A beam with larger strength at transmission (e.g., according to the beamforming used) than another beam does may not necessarily have larger strength at the receiver, and vice versa, for example due to interference and/or obstruction and/or dispersion and/or absorption and/or reflection and/or attrition or other effects influencing a beam or the signaling it carries. Signal quality may in general be a representation of how well a signal may be received over noise and/or interference. A beam with better signal quality than another beam does not necessarily have a larger beam strength than the other beam. Signal quality may be represented for example by SIR, SNR, SINR, BER, BLER, Energy per resource element over noise/interference or another corresponding quality measure. Signal quality and/or signal strength may pertain to, and/or may be measured with respect to, a beam, and/or specific signaling carried by the beam, e.g., reference signaling and/or a specific channel, e.g., a data channel or control channel. Signal strength may be represented by received signal strength, and/or relative signal strength, e.g., in comparison to a reference signal (strength).

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In describing some embodiments of the present disclosure, the following system variables may be used:
M is a number of downlink MIMO layers;
N is a number of base station antenna ports, i.e., an independently controllable number of subarrays, e.g., from a baseband; and
U is a number of subcarriers.

The following system variables may be described as:
s is a M×1 vector of the DL control and traffic signaling in the layer domain for each downlink subcarrier.
x is a N×1 vector of the pre-coded DL control and traffic signaling in the antenna domain for each downlink subcarrier.
H is a M×N matrix of the channel response from the base station to the WDs (UEs) for each downlink subcarrier.
W is a N×M matrix of the beamforming weights for each of the DL subcarriers (e.g., PRB granularity may be used to reduce the implementation cost).

Some embodiments provide precoding in circulator-less radio architectures, and techniques for optimization of such precoding.

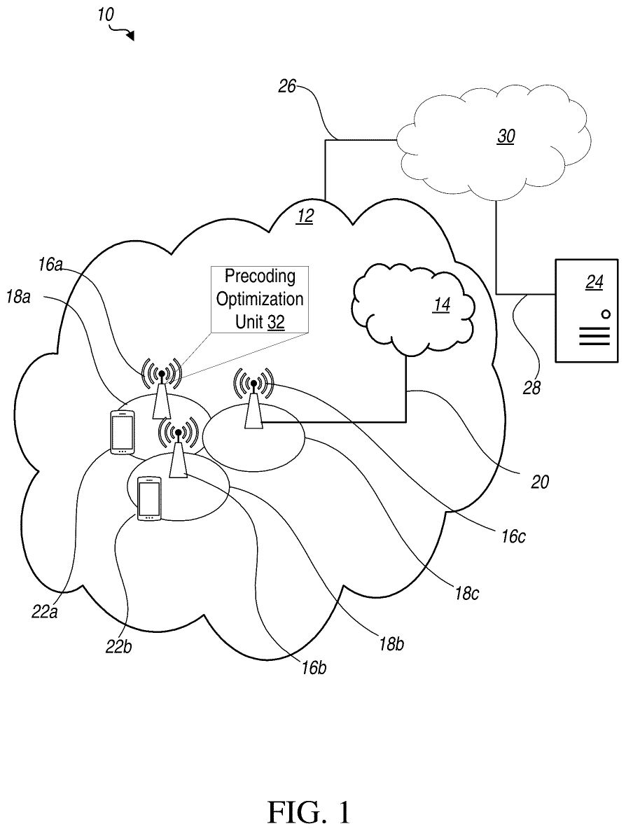

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a Precoding Optimization unit 32 which is configured for precoding for circulator-less radio architectures.

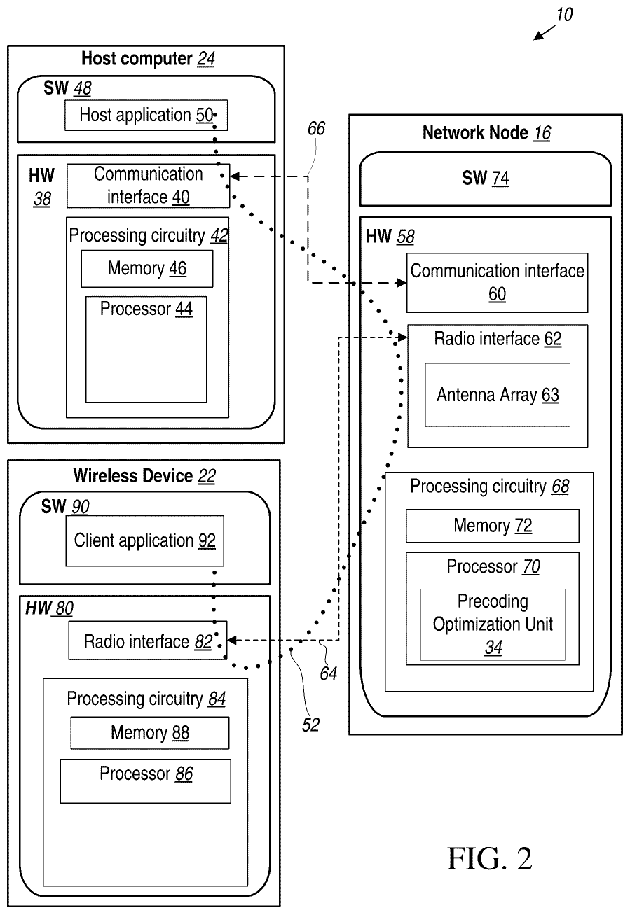

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 (including antenna array 63) for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. Antenna array 63 may include one or more antenna elements which may be arranged, e.g., linearly, two dimensionally, or three dimensionally. In some embodiments, antenna array 63 may be a circulator-less radio architecture. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include Precoding Optimization unit 32 configured for precoding optimization for circulator-less radio architectures.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as Precoding Optimization unit 32 as being within a respective processor, it is contemplated that these units may be implemented such that a portion of the unit is stored in a corresponding memory within the processing circuitry. In other words, the units may be implemented in hardware or in a combination of hardware and software within the processing circuitry.

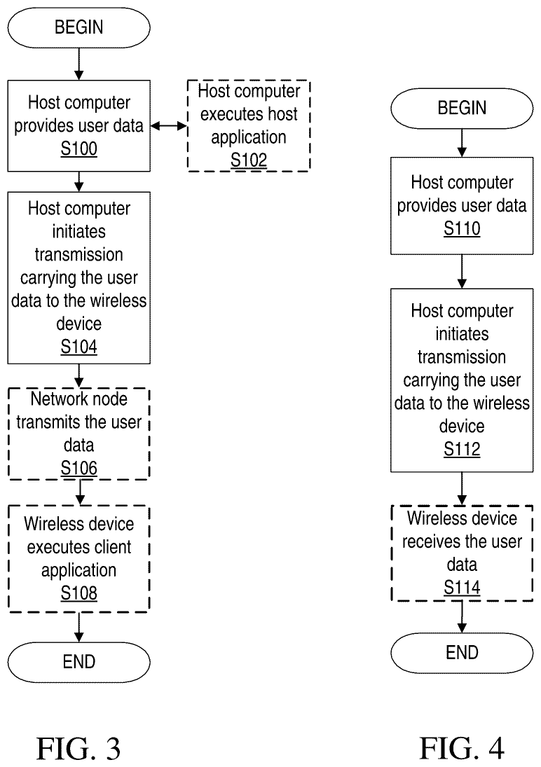

FIG. 3 is a flowchart illustrating an example method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

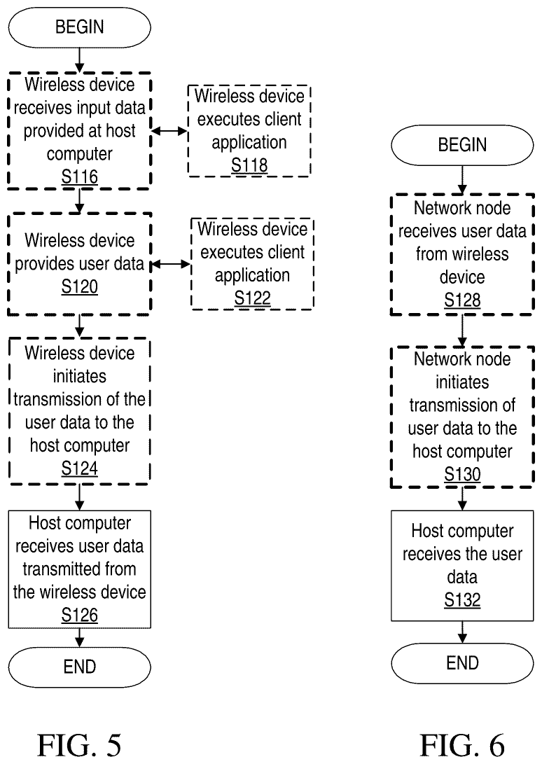

FIG. 5 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

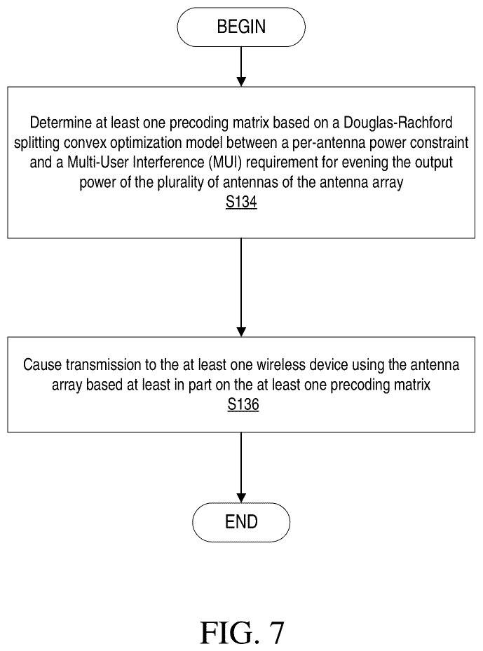

FIG. 7 is a flowchart of an example process in a network node 16 for precoding for circulator-less radio architectures. One or more blocks described herein may be performed by one or more elements of network node 16 such as by one or more of processing circuitry 68 (including the Precoding Optimization unit 32), processor 70, radio interface 62 (including antenna array 63) and/or communication interface 60. Network node 16 is configured to determine (Block S134) at least one precoding matrix based on a Douglas-Rachford splitting convex optimization model between a per-antenna power constraint and a Multi-User Interference (MUI) requirement for evening the output power of the plurality of antennas of the antenna array 63. Network node 16 is configured to cause transmission (Block S136) to the at least one wireless device 22 using the antenna array 63 based at least in part on the at least one precoding matrix.

In some embodiments, the determining of the at least one precoding matrix based on the Douglas-Rachford splitting convex optimization model includes initializing an intermediate error accumulator variable Z according to Z⁻¹=0. In some embodiments, the determining of the at least one precoding matrix based on the Douglas-Rachford splitting convex optimization model includes initializing a variable X according to one of a zero forcing solution, where the zero forcing solution is either regularized or not regularized, and a reshuffling of the Douglas-Rachford operations for improved algorithmic efficiency, where X is a matrix formed by horizontally stacking a plurality of antenna-domain solutions x for a plurality of subcarriers.

In some embodiments, the determining of the at least one precoding matrix based on the Douglas-Rachford splitting convex optimization model includes stopping the optimization model computation prior to reaching a minimum, where the stopping is based on at least one of a complexity of computation, a target per-antenna power spread value, a total additive perturbation power value, and an algorithm iteration count. In some embodiments, the optimization model is based on a first proximal operator associated with a projection of additive perturbations to a channel null space, and a second proximal operator associated with a per-antenna power rescaling. In some embodiments, the determining of the at least one precoding matrix based on the Douglas-Rachford splitting convex optimization model includes determining at least one projection matrix based on at least one of sounding reference signal, SRS, channel estimates, demodulation reference signal, DMRS, channel estimates, and second order channel statistics generated from processing at least one uplink physical channel. In some embodiments, the second order channel statistics are received with a higher periodicity than the SRS channel estimates. In some embodiments, the second order channel statistics include channel estimates associated with at least one of another wireless device 22 and another network node 16.

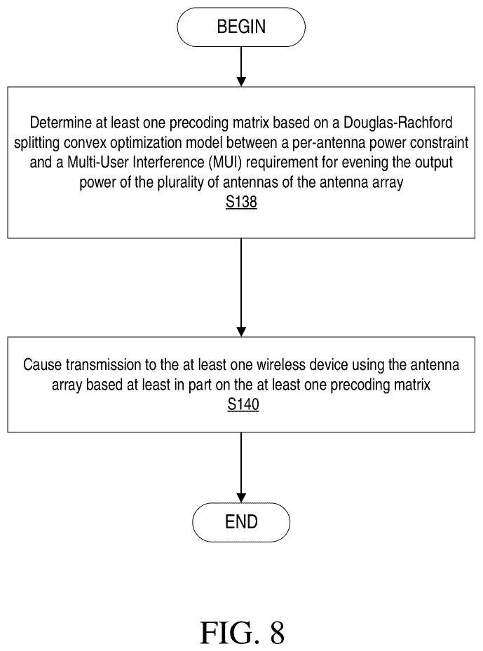

FIG. 8 is a flowchart of an example process in a communication system 10 (e.g., a wireless communication system 10) for precoding optimization for circulator-less radio architectures, including a network node 16 and one or more wireless device 22. One or more blocks described herein may be performed by one or more elements of communication system 10, including, e.g., network node 16, such as by one or more of processing circuitry 68 (including the Precoding Optimization unit 32), processor 70, radio interface 62, antenna array 63, and/or communication interface 60, and/or wireless device 22, such as by one or more of processing circuitry 84, processor 86, radio interface 82 and/or communication interface 60. Network node 16 is configured to determine (Block S138) at least one precoding matrix based on a Douglas-Rachford splitting convex optimization model between a per-antenna power constraint and a Multi-User Interference (MUI) requirement for evening the output power of the plurality of antennas of the antenna array 63. Network node 16 is configured to cause transmission (Block S140) to the at least one wireless device 22 using the antenna array 63 based at least in part on the at least one precoding matrix.

In some embodiments, the determining of the at least one precoding matrix based on the Douglas-Rachford splitting convex optimization model includes initializing an intermediate error accumulator variable Z according to Z⁻¹=0. In some embodiments, the determining of the at least one precoding matrix based on the Douglas-Rachford splitting convex optimization model includes initializing a variable X according to one of a zero forcing solution, where the zero forcing solution is either regularized or not regularized, and a reshuffling of the Douglas-Rachford operations for improved algorithmic efficiency, where X is a matrix formed by horizontally stacking a plurality of antenna-domain solutions x for a plurality of subcarriers.

In some embodiments, the determining of the at least one precoding matrix based on the Douglas-Rachford splitting convex optimization model includes stopping the optimization model computation prior to reaching a minimum, where the stopping is based on at least one of a complexity of computation, a target per-antenna power spread value, a total additive perturbation power value, and an algorithm iteration count. In some embodiments, the optimization model is based on a first proximal operator associated with a projection of additive perturbations to a channel null space, and a second proximal operator associated with a per-antenna power rescaling. In some embodiments, the determining of the at least one precoding matrix based on the Douglas-Rachford splitting convex optimization model includes determining at least one projection matrix based on at least one of sounding reference signal, SRS, channel estimates, demodulation reference signal, DMRS, channel estimates, and second order channel statistics generated from processing at least one uplink physical channel. In some embodiments, the second order channel statistics are received with a higher periodicity than the SRS channel estimates. In some embodiments, the second order channel statistics include channel estimates associated with at least one of another wireless device 22 and another network node 16.

Having described the general process flow of arrangements of the disclosure and having provided examples of hardware and software arrangements for implementing the processes and functions of the disclosure, the sections below provide details and examples of arrangements for precoding optimization for circulator-less radio architectures.

In some embodiments, the DL beamforming problem is treated/implemented as a constrained optimization between a “per-antenna” power constraint and a Multi-User Interference (MUI) requirement.

For example, two constraints using convex sets may be defined as follows:
[symbol] ={x: s_{ω}=H_{ω}x_{ω}, for ωϵ[1:U]} is defined as the MUI precoding constraint; and

$${𝒞}_{2} = \{ x : {\sum }_{ω = 1}^{U} t r ( {x}_{ω} {x}_{ω}^{H} ) = c \}$$

is the per-antenna power constraint, where c∈

$${ℝ}_{\geq 0}^{N \times 1}$$

is a vector containing the constant target power level c.

In this example, both the [symbol] and the [symbol] constraints are proper, closed, and convex sets. In addition, [symbol] is differentiable and linear with respect to the variable x, and is thus β-smooth with β≥0. The optimization problem may thereby be formulated as a composite convex problem, e.g., as follows:

$${minimize}_{X ϵ {ℂ}^{N \times U}} f ( X ) + g ( X ) \qquad ( Eq . 1 )$$

In some embodiments, the capitalized variable Xϵ [symbol] ^{N×U} may be formed by horizontally stacking the antenna-domain solutions x (e.g., a vertical dimension) for all subcarriers (e.g., a horizontal dimension).

In some embodiments, Equation 1 (Eq. 1) may be solved using a Douglas-Rachford (DR) splitting algorithm, e.g., as described by the iteration below:

$${z}^{k + 1} = ( ( 1 - α ) I + α {R}_{g} {R}_{f} ) {z}^{k} \qquad ( Eq . 2 )$$

### Where:

I is the identity operator;
αϵ[0, 1], with α=0.5 being a typical example value (although any value in the range may be used);
R_{g}=2·R_{f}−I is the reflected proximal operator; and

$${R}_{f} = {arg min}_{x} \{ f ( x ) + \frac{1}{2} ‖ x - z {‖}^{2} \}$$

is the proximal operator.

In some embodiments, the DR algorithm iteration may be summarized as follows:

$${Z}^{0} = 0 \qquad ( Eq . 3 )$$

$$for k = 1 , 2 , … do$$

$${X}^{k} = {prox}_{f} ( {Z}^{k - 1} )$$

$${Y}^{k} = {prox}_{g} ( 2 {X}^{k} - {Z}^{k - 1} )$$

$${Z}^{k} = {Z}^{k - 1} + 2 α ( {Y}^{k} - {X}^{k} )$$

$$end for$$

The prox_{f}(z) function may be derived following the standard proximal operator definition:

$${prox}_{f} ( z ) = {arg min}_{x} \{ f ( x ) + \frac{1}{2} {‖ x - z ‖}^{2} \} \qquad ( Eq . 4 )$$

(Eq. 4) may in turn be formulated as a constrained optimization problem which operates on one column of the X matrix at a time:

$$( {prox}_{f} ( z ) ) \{ \begin{matrix}{Minimize}_{x} & \frac{1}{2} {‖ x - z ‖}^{2} \\ subject to & s = Hx\end{matrix} \qquad ( Eq . 5 )$$

The optimization problem of Equation 5 (Eq. 5) may be solved using Lagrange multipliers:

$$L ( x , λ ) = \frac{1}{2} {‖ x - z ‖}^{2} + {λ}^{T} ( s - H x ) \qquad ( Eq . 6 )$$

Where λ is a M×1 vector of Lagrange multipliers and (·)^{T} is a vector transpose operation. Setting to zero the two partial derivatives of the Lagrange function (Eq. 6) with respect to the x and λ variables produces:

$${∇}_{x} L = {x}^{H} - {z}^{H} - {λ}^{T} \cdot H = 0 \qquad ( Eq . 7 )$$

$${∇}_{λ} L = s - H x = 0 \qquad ( Eq . 8 )$$

Where the (·)^{H} operator denotes the matrix Hermitian (i.e., complex conjugate) transpose.

Isolating x in (Eq. 7) yields:

$$x = z + {H}^{H} \cdot λ \qquad ( Eq . 9 )$$

Substituting (Eq. 9) into (Eq. 8) to find λ:

$$λ = {( H {H}^{H} )}^{- 1} ( s - H z ) \qquad ( Eq . 10 )$$

Substituting (Eq. 10) back into (Eq. 9):

$$\begin{matrix}x = z + {H}^{H} [ {( H {H}^{H} )}^{- 1} ( s - H z ) ] \\ = z - {H}^{H} [ {( H {H}^{H} )}^{- 1} ( H z - s ) ] \\ = z - {{H}^{H} ( H {H}^{H} )}^{- 1} H z + {{H}^{H} ( H {H}^{H} )}^{- 1} s \\ = ( I - {{H}^{H} ( H {H}^{H} )}^{- 1} H ) z + {{H}^{H} ( H {H}^{H} )}^{- 1} s\end{matrix} \qquad ( Eq . 11 )$$

Two observations can be made from equation (Eq. 11):
The H^{H}(HH^{H})⁻¹s term corresponds to the zero-forcing solution

$${x}_{ω}^{R Z F} ,$$

where the matrix inverse may be regularized for numerical stability.
The (I−H^{H}(HH^{H})⁻¹H)z term corresponds to the z vector projection onto the channel null space I−H^{H}(HH^{H})⁻¹H.

From this, (Eq. 11) may be re-written as:

$${x}_{ω} = {x}_{ω}^{R Z F} + {P}_{ω} {z}_{ω} \qquad ( Eq . 12 )$$

Where the P projection matrix is defined as:

$$P = I - {{H}^{H} ( H {H}^{H} )}^{- 1} H \qquad ( Eq . 13 )$$

The prox_{g}(u) function may be derived following a similar approach:

$$p r o {x}_{g} ( u ) = {arg min}_{y} \{ g ( y ) + \frac{1}{2} {‖ y - u ‖}^{2} \} \qquad ( Eq . 14 )$$

The derivation may be performed using a generic variable u which may be replaced by the proper 2x−z term later. This second proximal operator maneuvers along the horizontal dimension; one antenna at the time and considering all subcarriers. The lower-case bold variables in equations (Eq. 15) through (Eq. 23) may thus refer to horizontal row vectors.

(Eq. 14) may also correspond to a constrained linear optimization problem:

$$( p r o {x}_{f} ( {u}_{r o w} ) ) \{ \begin{matrix}{Minimize}_{x} \frac{1}{2} {‖ {y}_{row} - {u}_{row} ‖}^{2} \\ subject to {y}_{row} {y}_{row}^{H} = c\end{matrix} \qquad ( Eq . 15 )$$

The optimization problem of Equation (Eq. 15) can be solved using a Lagrange multiplier:

$$L ( y , λ ) = \frac{1}{2} {‖ y - u ‖}^{2} + λ ( y {y}^{H} - c ) \qquad ( Eq . 16 )$$

Where λ is a scalar Lagrange multiplier. Setting to zero the two partial derivatives of the Lagrange function (Eq. 16) with respect to the y and λ variables produces:

$${∇}_{y} L = {y}^{H} - {u}^{H} + {y}^{H} λ = 0 \qquad ( Eq . 17 )$$

$${∇}_{λ} L = y {y}^{H} - c = 0 \qquad ( Eq . 18 )$$

Where the (·)^{H} operator denotes the matrix Hermitian (i.e., complex conjugate) transpose.

Isolating y in (Eq. 17) yields:

$$y = \frac{1}{1 + λ} u \qquad ( Eq . 19 )$$

Substituting (Eq. 19) into (Eq. 18) to find λ produces:

$$\frac{u {u}^{H}}{{( 1 + λ )}^{2}} = c \qquad ( Eq . 20 )$$

From (Eq. 20), the following may be obtained:

$$⇒ {λ}^{2} + 2 λ + ( 1 - \frac{u {u}^{H}}{c} ) = 0 \qquad ( Eq . 21 )$$

Solving (Eq. 21) using the quadratic equation yields:

$$λ = - 1 \pm \sqrt{\frac{u {u}^{H}}{c}} \qquad ( Eq . 22 )$$

Selecting the positive root in (Eq. 22) and substituting the result into (Eq. 19) yields:

$$y = u \sqrt{\frac{c}{u {u}^{H}}} \qquad ( Eq . 23 )$$

In (Eq. 23), the prox_{f}(u) operator scales the u vector by the gain required to meet the c target power level for each antenna branch.

Thus, the Douglas-Rachford algorithm from (Eq. 3) may be expanded according to the following first algorithm.

Algorithm 1
Power Equalized RAT Using DR

| | |
|---|---|
| 1: | Initialize α = 0.5 |
| 2: | Initialize per-antenna target power level c |
| 3: | for ω = 1, ... , U do |
| 4: | ${P}_{ω} ← I - {{H}_{ω}^{H} ( {H}_{ω} {H}_{ω}^{H} )}^{- 1} {H}_{ω}$ |
| 5: | end for |
| 6: | Z⁰ ← 0 |
| 7: | for k = 0, 1, 2, ... do |
| 8: | for ω = 1, ... , U do |
| 9: | ${x}_{ω}^{k} = {x}_{RZF , ω} + {P}_{ω} {z}_{ω}^{k}$ |
| 10: | end for |
| 11: | U = 2X^{k} − Z^{k} |
| 12: | for m = 1, ... , M do |
| 13: | ${y}_{row , m}^{k} = {u}_{row , m} \sqrt{\frac{c}{{u}_{row , m} {u}_{row , m}^{H}}}$ |
| 14: | end for |
| 15: | Z^{k+1} = Z^{k} + 2α(Y^{k} − X^{k}) |
| 16: | end for |

### Algorithm Initial State and Operation Sequence

In some embodiments, Line 7 of Algorithm 1 (i.e., the “x-update”) may be counterproductive during the first iteration, as it may simply project the all-zero vector onto the channel null space. The x-update will then produce the X_{RZF} regularized zero-forcing (RZF) solution. The U variable is then assigned the 2X_{RZF} value on Line 11 of the first iteration.

Therefore, some embodiments of the present disclosure may apply a cyclic shift to the operations from x_{update}→y_{update}→z_{update} to y_{update}→z_{update}→x_{update} and instead jump start the algorithm by initializing the variables to X⁻¹=X_{RZF} and Z⁻¹=0, where Z is an intermediate error accumulator variable

The second algorithm below, Algorithm 2, presents an example method according to some embodiments of the present disclosure after the above described re-sequencing operation.

Algorithm 2
Proposed Power Equalized RAT

| | |
|---|---|
| 1: | Initialize α = 0.5 |
| 2: | Initialize per-antenna target power level c |
| 3: | for ω = 1, ... , U do |
| 4: | ${P}_{ω} ← I - {{H}_{ω}^{H} ( {H}_{ω} {H}_{ω}^{H} )}^{- 1} {H}_{ω}$ |
| 5: | end for |
| 6: | X⁻¹ ← X_{RZF} |
| 7: | Z⁻¹ ← 0 |
| 8: | for k = 0, 1, 2, ... do |
| 9: | U = 2X^{k-1} − Z^{k-1} |
| 10: | for m = 1, ... , M do |
| 11: | ${y}_{row , m}^{k} = {u}_{row , m} \sqrt{\frac{c}{{u}_{row , m} {u}_{row , m}^{H}}}$ |
| 12: | end for |
| 13: | ${Z}^{k} = {Z}^{k - 1} + 2 α ( {Y}^{k} - {X}^{k - 1} )$ |
| 14: | for ω = 1, ... , U do |
| 15: | ${x}_{ω}^{k} = {x}_{RZF , ω} + {P}_{ω} {z}_{ω}^{k}$ |
| 16: | end for |
| 17: | end for |

Once some or all algorithm iterations are completed, the X^{final} variable (and/or an indication/index/mapping/quantization/etc. thereof) may be transmitted over the downlink wireless channel, e.g., to wireless device 22.

### Simulation Results

The performance of some example embodiments of the present disclosure has been evaluated using the 3GPP 5G SCM channel model from 3GPP TR 38.901 over 200 channel realizations. Each channel realization has a random user placement within a single sector with 500 meters radius. The simulations were performed at a frequency of 3.5 GHZ, using a 40 MHz NR carrier with 30 KHz subcarrier spacing, and 80 Watts of transmit power.

The network node 16 (e.g., base station 16) in the simulation example has an antenna array 63 including 4 rows and 8 columns, while the wireless device 22 (e.g., a user terminal, a UE, etc.) is equipped with a single antenna. Two scenarios were evaluated:
Simulation Scenario 1: Four users, Urban-Macro (UMa), non-line-of-sight (NLOS), 80% of users (wireless devices 22) located indoor.
Simulation Scenario 2: One user, Urban-Macro (UMa), line-of-sight (LOS), outdoor users (wireless devices 22) only.

The simulations results are as follows.

### Simulation Scenario 1

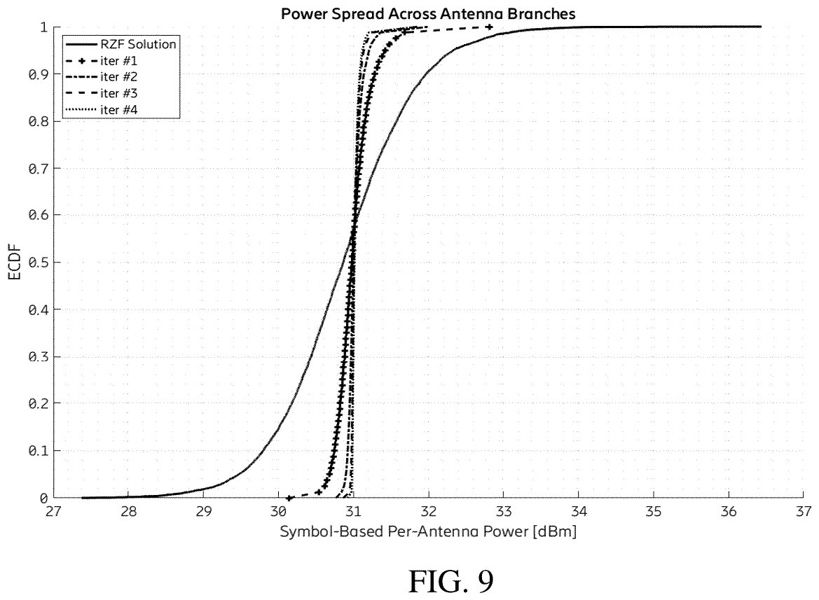

FIG. 9 depicts the Empirical CDF (ECDF) of the per-antenna power spread over the algorithm iterations for Simulation Scenario 1, which corresponds to a rich-fading propagation environment. It can be observed that the initial RZF solution has about 10 decibels of worst-case power spread. This is reduced to under 3 dB in one algorithm iteration.

Referring still to FIG. 9, the algorithm convergence may not be determined by the worst-case power spread, but rather by the delta between the 90th and the 10th percentiles as shown in Table 1 below. Table 1 shows that the method yields diminishing returns after three iterations in Simulation Scenario 1.

TABLE 1
90th-10th Percentile Power Spread

| | 90th-10th Percentile |
|---|---|
| Iteration Index | Power Spread [dB] |
| 1 | 0.54 |
| 2 | 0.23 |
| 3 | 0.16 |
| 4 | 0.13 |

Thus, these simulation results suggest that embodiments of the present disclosure may produce significant improvements over the RZF baseline, even after only one iteration, such as under conditions similar to Simulation Scenario 1. Thus, the algorithm could be stopped after one, two or three iterations (e.g., and still produce useful improvement). The number of iterations to perform may depend on/be determined based on the computational complexity that can be afforded in the implementation (e.g., based on processing resources available to network node 16, amount of time available to perform computations, etc.).

Embodiments of the present disclosure may increase the total transmit power, e.g., as seen from Line 15 of Algorithm 2 above, since some perturbations may be injected into the channel null space.

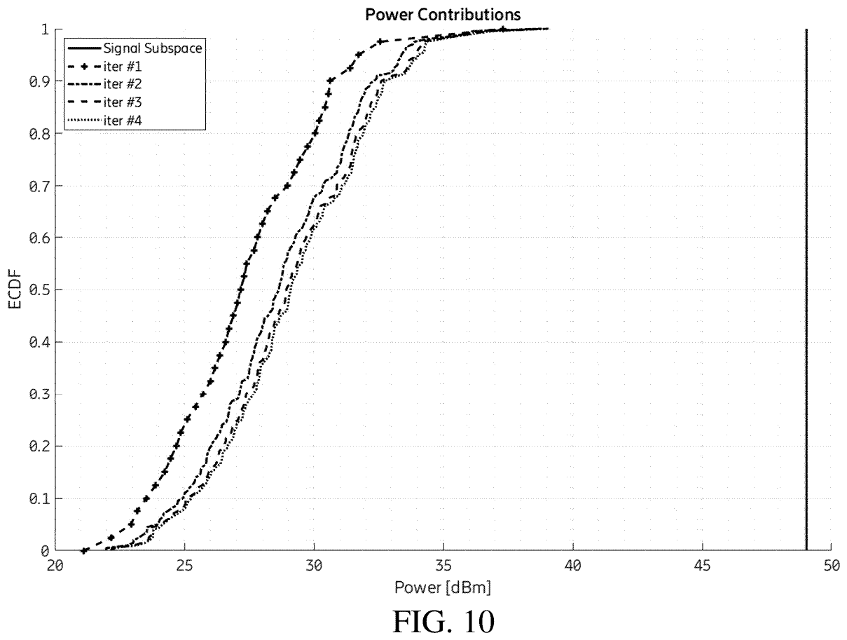

FIG. 10 illustrates the ECDF of the various power contributions across the algorithm iterations, according to some embodiments of the present disclosure, in Simulation Scenario 2.

The “power penalty” associated with the proposed technique may increase with the iteration count. In some examples, the power in the channel null space may be raised by about 2 dB's at the 50th percentile between the first and the fourth iteration. Nevertheless, even after four iterations, the power in the channel null space is 20 dBs below that of the desired signal at the 50th percentile, i.e., 1/100th of the power.

### Simulation Scenario 2

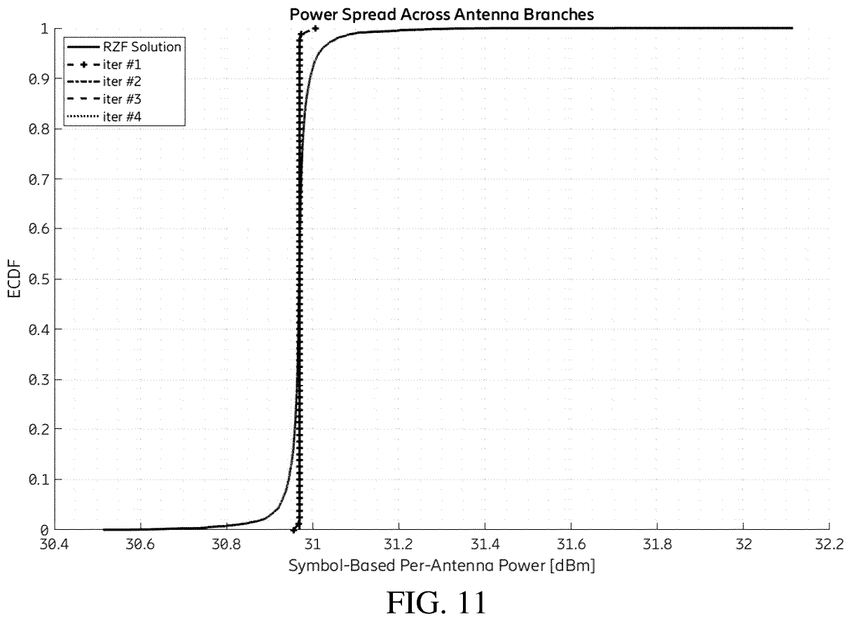

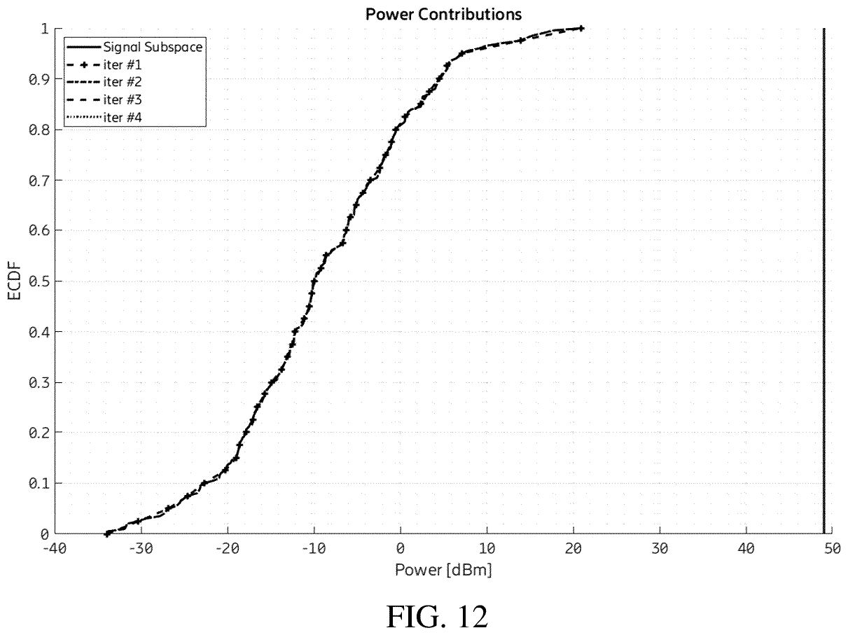

FIG. 11 and FIG. 12 illustrate example simulated performance metrics of some embodiments of the present disclosure in a second scenario, Simulation Scenario 2, which corresponds to a flat-fading line-of-sight (LoS) propagation environment.

FIG. 11 illustrates an example of the ECDF of the per-antenna power spread across the iterations. In this scenario, the RZF baseline has a much more desirable distribution, such that the algorithm converges much faster. Here, a “close to optimal” solution is reached after the first iteration where a 0.02 dB power delta is computed between the 90th percentile and the 10th percentile.

FIG. 12 depicts an example graph of power contributions ECDF over the algorithm iterations for Simulation Scenario 2. In the example of FIG. 12, the additive perturbation power level is 34.5 dB below that of the desired signal at the 50th percentile. In this scenario, the perturbation power level is stable across the iterations.

### Null Space Estimation Mismatches with Large SRS Periodicities

In some embodiments, the channel null space estimation accuracy may decrease with increasing SRS periodicities. This may introduce EVM at the wireless devices 22 in the downlink due to the projection term being not perfectly aligned with the actual users' channel null space. However, the total perturbation power level is typically 20 dB below that of the desired signal, as illustrated from the simulation results of FIG. 10 and FIG. 12. Thus, the EVM penalty should be somewhat reasonable.

In addition, in some embodiments, an alternative channel estimation method producing second order channel statistics can be used to decouple the channel estimation refresh rate from the SRS periodicity and thus improve the downlink EVM at the wireless devices 22.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
3GPP Third Generation Partnership Project
5G Fifth Generation
dB Decibel
DL Downlink
DR Douglas-Rachford splitting algorithm
ECDF Empirical Cumulative Distribution Function
EVM Error Vector Magnitude
LOS Line-of-Sight
MIMO Multiple-Input Multiple-Output
MUI Multi-User Interference
NLOS Non-Line-of-Sight
PA Power Amplifier
PRB Physical Resource Block
RAT Reciprocity-Assisted Transmission
RZF Regularized Zero-Forcing
SCM Spatial Channel Model
SRS Sounding Reference Symbols
UE User Equipment
UMa Urban-Macro

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A network node configured to communicate with at least one wireless device, the network node comprising processing circuitry and an antenna array, the antenna array including a plurality of antennas, the processing circuitry being configured to:
determine at least one precoding matrix based on a Douglas-Rachford splitting convex optimization model between a per-antenna power constraint and a Multi-User Interference (MUI) requirement for evening the output power of the plurality of antennas of the antenna array; and
cause transmission to the at least one wireless device using the antenna array based at least in part on the at least one precoding matrix.

2. The network node of claim 1, wherein the determining of the at least one precoding matrix based on the Douglas-Rachford splitting convex optimization model includes initializing an intermediate error accumulator variable Z according to Z⁻¹=0.

3. The network node of claim 1, wherein the determining of the at least one precoding matrix based on the Douglas-Rachford splitting convex optimization model includes initializing a variable X according to one of a zero forcing solution, the zero forcing solution being one of regularized and not regularized, and a reshuffling of the Douglas-Rachford operations for improved algorithmic efficiency, X being a matrix formed by horizontally stacking a plurality of antenna-domain solutions x for a plurality of subcarriers.

4. The network node of claim 1, wherein the determining of the at least one precoding matrix based on the Douglas-Rachford splitting convex optimization model includes stopping the optimization model computation prior to reaching a minimum, the stopping being based on at least one of:
a complexity of computation;
a target per-antenna power spread value;
a total additive perturbation power value; and
an algorithm iteration count.

5. The network node of claim 1, wherein the optimization model is based on:
a first proximal operator associated with a projection of additive perturbations to a channel null space; and
a second proximal operator associated with a per-antenna power rescaling.

6. The network node of claim 2, wherein the determining of the at least one precoding matrix based on the Douglas-Rachford splitting convex optimization model includes determining at least one projection matrix based on at least one of:
sounding reference signal, SRS, channel estimates;
demodulation reference signal, DMRS, channel estimates; and
second order channel statistics generated from processing at least one uplink physical channel.

7. The network node of claim 6, wherein the second order channel statistics are received with a higher periodicity than the SRS channel estimates.

8. The network node of claim 6, wherein the second order channel statistics include channel estimates associated with at least one of:
another wireless device; and
another network node.

9. A method implemented in a network node configured to communicate with at least one wireless device, the network node comprising an antenna array including a plurality of antennas, the method comprising:
determining at least one precoding matrix based on a Douglas-Rachford splitting convex optimization model between a per-antenna power constraint and a Multi-User Interference (MUI) requirement for evening the output power of the plurality of antennas of the antenna array; and
causing transmission to the at least one wireless device using the antenna array based at least in part on the at least one precoding matrix.

10. The method of claim 9, wherein the determining of the at least one precoding matrix based on the Douglas-Rachford splitting convex optimization model includes initializing an intermediate error accumulator variable Z according to Z⁻¹=0.

11. The method of claim 9, wherein the determining of the at least one precoding matrix based on the Douglas-Rachford splitting convex optimization model includes initializing a variable X according to one of a zero forcing solution, the zero forcing solution being one of regularized and not regularized, and a reshuffling of the Douglas-Rachford operations for improved algorithmic efficiency, X being a matrix formed by horizontally stacking a plurality of antenna-domain solutions x for a plurality of subcarriers.

12. The method of claim 9, wherein the determining of the at least one precoding matrix based on the Douglas-Rachford splitting convex optimization model includes stopping the optimization model computation prior to reaching a minimum, the stopping being based on at least one of:
a complexity of computation;
a target per-antenna power spread value;
a total additive perturbation power value; and
an algorithm iteration count.

13. The method of claim 9, wherein the optimization model is based on:
a first proximal operator associated with a projection of additive perturbations to a channel null space; and
a second proximal operator associated with a per-antenna power rescaling.

14. The method of claim 10, wherein the determining of the at least one precoding matrix based on the Douglas-Rachford splitting convex optimization model includes determining at least one projection matrix based on at least one of:
sounding reference signal, SRS, channel estimates;
demodulation reference signal, DMRS, channel estimates; and
second order channel statistics generated from processing at least one uplink physical channel.

15. The method of claim 14, wherein the second order channel statistics are received with a higher periodicity than the SRS channel estimates.

16. The method of claim 14, wherein the second order channel statistics include channel estimates associated with at least one of:
another wireless device; and
another network node.

17. A wireless communication system, comprising:
at least one wireless device; and
a network node configured to communicate with the at least one wireless device, the network node comprising processing circuitry and an antenna array, the antenna array including a plurality of antennas, the processing circuitry being configured to:
determine at least one precoding matrix based on a Douglas-Rachford splitting convex optimization model between a per-antenna power constraint and a Multi-User Interference (MUI) requirement for evening the output power of the plurality of antennas of the antenna array; and
cause transmission to the at least one wireless device using the antenna array based at least in part on the at least one precoding matrix.

18. The wireless communication system of claim 17, wherein the determining of the at least one precoding matrix based on the Douglas-Rachford splitting convex optimization model includes initializing an intermediate error accumulator variable Z according to Z⁻¹=0.

19. The wireless communication system of claim 17, wherein the determining of the at least one precoding matrix based on the Douglas-Rachford splitting convex optimization model includes initializing a variable X according to one of a zero forcing solution, the zero forcing solution being one of regularized and not regularized, and a reshuffling of the Douglas-Rachford operations for improved algorithmic efficiency, X being a matrix formed by horizontally stacking a plurality of antenna-domain solutions x for a plurality of subcarriers.

20. The wireless communication system of claim 17, wherein the determining of the at least one precoding matrix based on the Douglas-Rachford splitting convex optimization model includes stopping the optimization model computation prior to reaching a minimum, the stopping being based on at least one of:
a complexity of computation;
a target per-antenna power spread value;
a total additive perturbation power value; and
an algorithm iteration count.

21-24. (canceled)
